(19) United States
(12) Patent Application Publication
(10) Pub. No.: US 2013/0052067 A1
(43) Pub. Date: Feb. 28, 2013

(54) Downhole Motors and Pumps with Improved Stators and Methods of Making and Using Same

(71) Applicants: Carsten Hohl, Hannover (DE); Harald Grimmer, Lachendorf (DE)

(72) Inventors: Carsten Hohl, Hannover (DE); Harald Grimmer, Lachendorf (DE)

(73) Assignee: BAKER HUGHES INCORPORATED, Houston, TX (US)

(21) Appl. No.: 13/219,289

(22) Filed: Aug. 26, 2011

(51) Int. Cl. F01C 1/22; B23P 15/00

(52) U.S. Cl. 418/48; 29/888.023

(57) ABSTRACT

In one aspect, the disclosure provides an apparatus for use downhole that in one configuration includes a stator including a housing having an inner contour and a liner lining the inner contour of the stator housing, wherein thickness of the liner is non-equidistant around the inner contour of the housing.

### BACKGROUND INFORMATION

1. Field of the Disclosure

This disclosure relates generally to drilling motors and progressive cavity pumps for use in wellbore operations.

2. Brief Description of the Related Art

To obtain hydrocarbons such as oil and gas, boreholes or wellbores are drilled by rotating a drill bit attached to a drill string end. A substantial proportion of current drilling activity involves drilling deviated and horizontal boreholes to increase the hydrocarbon production and/or to withdraw additional hydrocarbons from the earth's formations. Modern directional drilling systems generally employ a drill string having a drill bit at the bottom that is rotated by a positive displacement motor (commonly referred to as a “mud motor” or a “drilling motor”). A typical mud motor includes a power section that contains a stator and a rotor disposed in the stator. The stator typically includes a metal housing lined inside with a helically contoured or lobed elastomeric material. The rotor includes helically contoured lobes made from metal, such as steel. Pressurized drilling fluid (commonly known as the “mud” or “drilling fluid”) is pumped into a progressive cavity formed between the rotor and stator lobes. The force of the pressurized fluid pumped into the cavity causes the rotor to turn in a planetary-type motion. The elastomeric stator liner provides seal between the stator lobes and rotor lobes. The elastomeric liner also provides support for the rotor and thus remains under high load conditions during operation of the mud motor or the pump.

Conventional stators utilize two types of elastomeric liners. In one type, the inside of a metallic tube (“housing”) is lined with a non-uniform sized elastomeric material that has a helical lobed inner geometry. In the second type, the housing has an inner metallic helical lobed geometry. The inner metallic lobes are then lined with a uniform layer (i.e., equidistance or same thickness) of the elastomeric material. Although the equidistant rubber lining has certain advantages over the non-uniform sized elastomeric liner, there is a still a trade-off between reduced stress and strain on the uniform liner and the preservation of the volumetric efficiency and power output of the drilling motor.

The disclosure herein provides drilling motors that include an improved elastomeric liner geometry that addresses at least some of the deficiencies of the prior art elastomeric liners.

### SUMMARY

In one aspect, the disclosure provides an apparatus for use downhole, comprising: a stator including a housing having an inner contour; and a liner lining the inner contour of the stator housing, wherein thickness of the liner is non-equidistant around the inner contour.

In another aspect, a method providing an apparatus for use downhole is provided that in one embodiment includes: providing a stator that includes a housing having a lobed inner contour; and lining the inner contour of the stator housing with a liner, wherein thickness of the liner is non-equidistant around the lobed inner contour.

Examples of certain features of the apparatus and method disclosed herein are summarized rather broadly in order that the detailed description thereof that follows may be better understood. There are, of course, additional features of the apparatus and method disclosed hereinafter that will form the subject of the claims appended hereto.

### BRIEF DESCRIPTION OF THE DRAWINGS

For detailed understanding of the present disclosure, references should be made to the following detailed description, taken in conjunction with the accompanying drawings in which like elements have generally been designated with like numerals and wherein:

FIG. 1 is a longitudinal cross-section of a drilling motor that includes a stator made according to an embodiment of the disclosure;

FIG. 2 (Prior Art) is a cross-section of a prior art stator that includes a cylindrical hollow tube as the housing and an elastomeric liner therein;

FIG. 3 (Prior Art) is a cross-section of a prior art stator that includes a metallic housing with a preformed lobed contour lined with an equidistant (uniform thickness) elastomeric liner;

FIG. 4 is line diagram of a cross-section of a stator made according to an embodiment of the disclosure that also shows a cross-sectional layout of the prior art stator shown in FIG. 3; and

FIG. 5 is an enlarged view of a section of the stator shown in FIG. 4.

### DESCRIPTION OF THE EMBODIMENTS

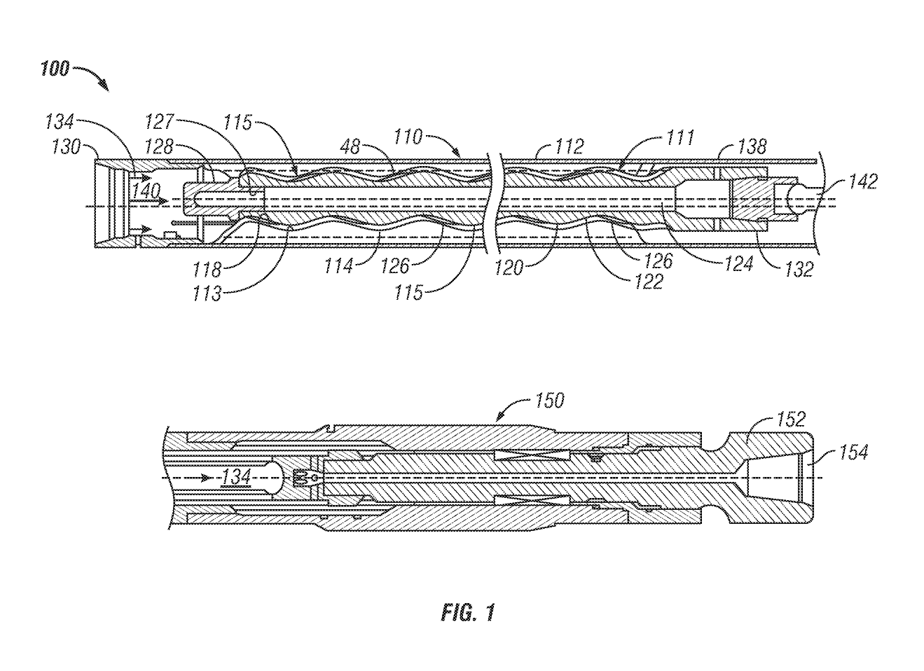

FIG. 1 shows a cross-section of an exemplary drilling motor 100 made according to an embodiment of the disclosure herein. The drilling motor 100 includes a power section 110 and a bearing assembly 150. The power section 110 contains a stator 111 and a rotor 120 placed inside the stator 111. The stator 111 includes an elongated metal housing 112 having a number of lobes 115 with an inner metallic lobed contour or profile 113. The stator housing 112 may be pre-formed with the inner metallic contour 113. The inner contour 113 of the stator housing is lined with an elastomeric liner 114 that includes an inner lobed contour 118. The liner 114 is secured inside the housing 112 by a suitable process, such as molding, vulcanization, etc. The rotor 120 is typically made of a suitable metal or an alloy and includes lobes 122. The stator 111 includes one lobe more than the number of rotor lobes. The rotor 120 is rotatably disposed inside the stator 111. In aspects, the rotor 120 may include a bore 124 that terminates at a location 127 below the upper end 128 of the rotor 120 as shown in FIG. 1. The bore 124 remains in fluid communication with the drilling fluid 140 below the rotor 120 via a port 138.

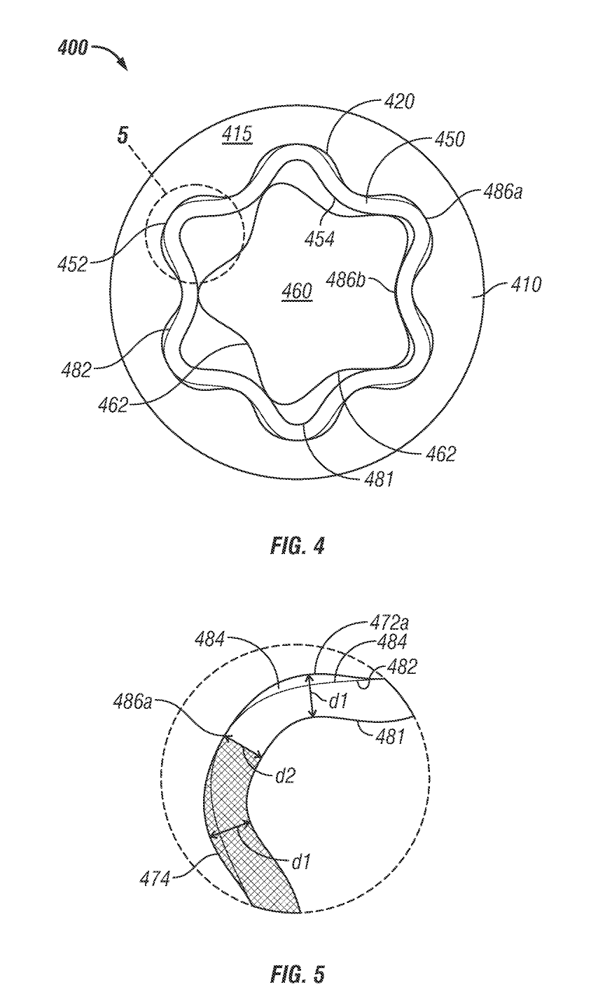

Still referring to FIG. 1, the rotor lobes 122, stator lobes 115 and their helical angles are configured such that the rotor lobes 122 and the stator lobes 115 seal at discrete intervals, resulting in the creation of axial fluid chambers or cavities 126. The drilling fluid 140 supplied under pressure to the mud motor 100 flows through the cavities 126, as shown by arrow 134, causing the rotor 120 to rotate inside the stator 110 in a planetary fashion. The design and number of the stator lobes 115 and rotor lobes 122 define the output characteristics of the drilling motor 100. In one configuration, the rotor 120 is coupled to a flexible shaft 142 that connects to a rotatable drive shaft 152 in the bearing assembly 150. A drill bit (not shown) is connected to a bottom end of the bearing assembly 150 at a suitable bit box 154. During a drilling operation, the pressurized fluid 140 rotates the rotor 120 that in turn rotates the flexible shaft 142. The flexible shaft 142 rotates the drill shaft 152 that, in turn, rotates the bit box 154 and thus the drill bit. In other aspects, the stator housing may be made of any non-elastomeric material, including, but not limited to, a ceramic or ceramic-based material, reinforced carbon fibers, and a combination of a metallic and a non-metallic material. Also, the rotor may be made from any suitable material, including, but not limited to, ceramic, ceramic-based material, carbon fibers, and a combination of a metallic and a non-metallic material. Stators made according to an embodiment of this disclosure are described in reference to FIGS. 4 and 5. It is, however, considered helpful to describe typical configurations for certain currently made stators.

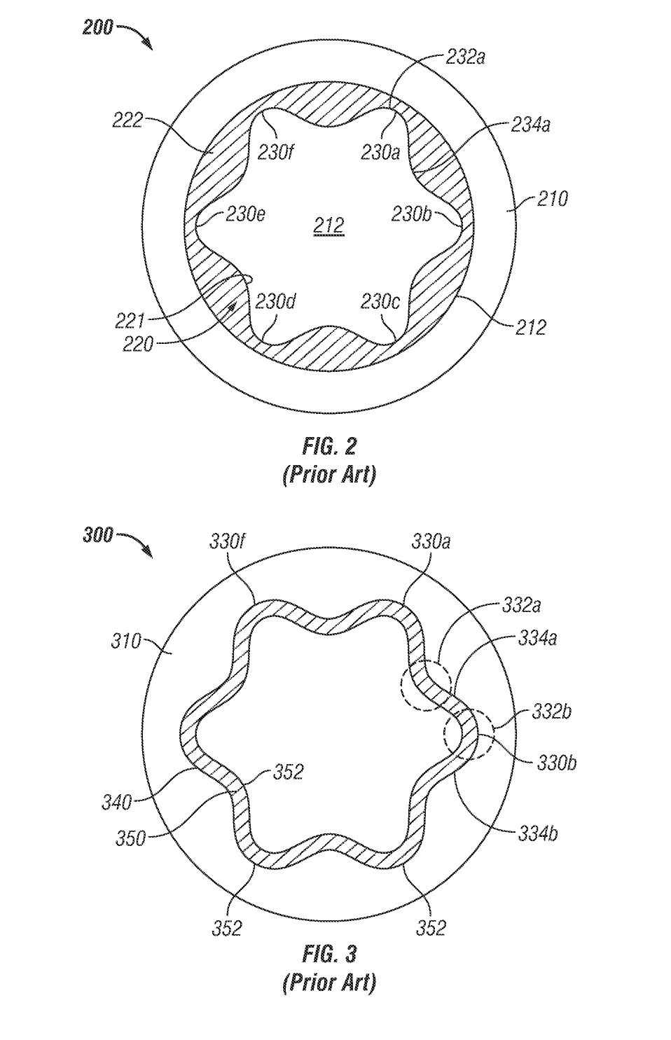

FIG. 2 (Prior Art) shows a cross-section of a prior art stator 200 that includes a metal housing 210 that has a straight bore 212 therethrough. The Stator 200 is lined with a liner 220 made from an elastomeric material 222, such as rubber. The inner surface 221 of the liner 220 has a helically contoured surface that includes a number of lobes, such as lobes 230a-230f. Each such lobe has a lobe bottom and a lobe top. For example, lobe 230a includes a lobe bottom 232a and a lobe top 234a. In the stator 200 shown in FIG. 2, the thickness of the liner 220 varies. The inner lobed profile 221 is compliant with the lobed profile of the rotor as described later.

FIG. 3 (Prior Art) shows a cross-section of a prior art stator 300, wherein a stator housing 310 is made from a metal that includes a number of lobes 330a-330f having an inner metallic contour or profile 340. The inner profile 340 of the stator housing 310 is lined with an equidistant (same thickness) elastomeric liner (or lining) 350 whose outer lobed contour 352 matches the inner lobed contour 354 of the stator housing 310. The liner 350 follows the contour 354. Each of the stator lobes (330a-330f) includes a lobe bottom and a lobe top. For example, lobe 330b has a lobe top 332a and a lobe bottom 332b. Further, each lobe has a leading side and a trailing side, wherein the leading side experiences higher load than the trailing side during operation of the mud motor. The leading side for lobe 330b is 334a while the trailing side is 334b.

Still referring to FIG. 3, although the equidistant elastomeric liner 350 has several advantages, it does not necessarily provide the best outer contour for the liner 350 of the stator housing 310. The effort to optimize the performance of an equidistant elastomeric liner 350, such a rubber liner, is affected by a trade-off between reduction of stresses and strains on the liner 350 and the preservation of the volumetric efficiency and power output of the mud motor or the pump. It is known that increasing the rubber thickness on the lobes of a uniform liner can provide a substantial decrease in stresses and strains but also results in a reduced volumetric efficiency of the mud motor and a lower effective temperature transportation. The inventors, however, have determined that increasing the elastomeric material thickness between the lobes (near the lobe top or valley results in a limited decrease of stresses and strains (up to 25%) and a relatively small loss of volumetric efficiency at higher local temperatures than thinner equidistant rubber lining, but still has full height steel pre-contour to transport heat effectively from the stator liner. An exemplary stator liner contour made according one embodiment and method of the disclosure is described in reference to FIGS. 4 and 5.

FIG. 4 shows a line drawing of cross-section of the power section of a mud motor 400 made according to an embodiment of this disclosure. FIG. 5 shows an exploded section of the stator of FIG. 4. The mud motor 400 includes a stator 410 that includes a stator housing 415 that has an inner metallic lobed contour 420 made according to an embodiment of the disclosure. The inner lobed contour 420 of the stator housing 415 is lined with a liner or lining 450. The outer contour 452 of the liner 450 matches the inner contour 420 of the housing 415. The liner 450 is a non-equidistant thickness (or non-uniform thickness) liner compared to a uniform or equidistant liner, such as shown in FIG. 3. For comparison purposes, an equidistant liner 480 will have an inner contour 481 and an outer contour 482. The inner contour 481 of the non-equidistant liner 450 and the inner contour 481 of the equidistant liner 480 are the same. In aspects, the gap 484 between the inner contour 481 and the outer contour 482 defines the increased thickness of the non-equidistant liner 450 compared to the thickness of the equidistant liner 480.

Thus, in aspects, the thickness of the elastomeric liner 450 made according to an embodiment of the disclosure is non-uniform in a stator housing that has a pre-formed contoured surface. Each lobe in the stator 400 includes a lobe bottom and a lobe top. For example, in the lobe shown in FIG. 4, the lobe bottom indicated by 486a and the lobe top is indicated by 486b. The lobe top 486b has a leading side or edge 472 and a trailing side or edge 474. FIG. 5 shows an enlarged area “5” of stator 400 of FIG. 4. In the particular configuration of stator 400 shown in FIGS. 4 and 5, thickness “d1” of the liner 450 at leading side 472 and at the trailing side 474 is greater than the thickness “d2” between the inner contour 481 of the liner 450 and inner contour 482 of the stator housing 410 or the line 450 at the lobe bottom 486a. The distances d1 and/or d2 or their ratio may be adjusted based on the design need and the intended application and environment in which the drilling motor or the progressive cavity pump will be utilized. The liner thickness at the leading side 472 may be different from the liner thickness at the trailing edge 474.

Thus, in aspects, the disclosure provides an apparatus for use downhole, which apparatus in one embodiment includes a stator that includes a housing that has an inner contour and a liner is the inner contour, wherein the thickness of the liner is non-equidistant around the inner contour. In one aspect, the material for the inner contour and the liner may be different. In one configuration of the stator, the housing and the liner material may be a metallic material while the liner may be made of a suitable elastomeric material. In another aspect, the liner includes a number of lobes, each such lobe having a lobe top and a lobe bottom and wherein the liner includes a leading side and a trailing side and wherein thickness of the liner across the leading edge and/or the trailing edge is greater than thickness of the liner between the lobe top and the lobe bottom. In another configuration, the thickness of the leading edge may be greater than thickness of the liner at the trailing edge or less than the thickness of the liner at the trailing edge. In aspects, a rotor having one less lobe than the stator is disposed in the stator to form a power section of a drilling motor, a progressive cavity pump or another suitable Moineau device. In another configuration, housing material my be a ceramic material, a composite material, a carbon fiber material, a metal alloy or a combination of a metal and anon-metallic material and the liner material may be any suitable elastomeric material. In other aspects, the apparatus may include a drill bit and a number of sensors and may be coupled to tubular string.

The foregoing description is directed to particular embodiments for the purpose of illustration and explanation. It will be apparent, however, to persons skilled in the art that many modifications and changes to the embodiments set forth above may be made without departing from the scope and spirit of the concepts and embodiments disclosed herein. It is intended that the following claims be interpreted to embrace all such modifications and changes.

1. An apparatus for use downhole, comprising:
a stator including a housing having an inner contour; and
a liner lining the inner contour of the stator housing, wherein thickness of the liner is non-equidistant around the inner contour of the housing.

2. The apparatus of claim 1, wherein the inner contour in the housing is made of a first material and the liner is made of a second material that differs from the first material.

3. The apparatus of claim 2, wherein the first material includes a metal and the second material is an elastomeric material.

4. The apparatus of claim 1, wherein the inner contour of the stator housing includes a lobe having a lobe top and a lobe bottom and wherein the liner includes a leading side and a trailing side and wherein thickness of the liner across one of the leading edge and the trailing edge is greater than thickness of the liner between the lobe top and the lobe bottom.

5. The apparatus of claim 4, wherein thickness of the leading edge is one of: (i) greater than thickness of the liner at the trailing edge; and (ii) less than the thickness of the liner at the trailing edge.

6. The apparatus of claim 1 further comprising a rotor disposed in the stator, the rotor including lobe configured to rotate in the stator.

7. The apparatus of claim 1, wherein the first material is selected from a group consisting of: a ceramic material, a composite material; a carbon fiber material; a metal alloy; and a combination of a metal and a non-metallic material.

8. The apparatus of claim 7, wherein the apparatus is configured to operate as one of a drilling motor and a progressive cavity pump.

9. The apparatus of claim 7 further comprising a drill bit coupled to the rotor.

10. A method of providing an apparatus for use downhole, comprising:
providing a stator that includes a housing having a lobed inner contour; and
lining the inner contour of the stator housing with a liner, wherein thickness of the liner is non-equidistant around the lobed inner contour.

11. The method of claim 10, wherein providing a stator comprises providing the stator housing made of a first material and the liner made of a second material that differs from the first material.

12. The method of claim 11, wherein the first material includes a metal and the second material is an elastomeric material.

13. The method of claim 10, wherein the liner in the housing includes a lobe having a lobe top and a lobe bottom and wherein the liner includes a leading side and a trailing side and wherein thickness of the liner across one of the leading edge and the trailing edge is greater than thickness of the liner between the lobe top and the lobe bottom.

14. The apparatus of claim 13, wherein thickness of the leading edge is one of: (i) greater than thickness of the liner at the trailing edge; and (ii) less than the thickness of the liner at the trailing edge.

15. The method of claim 10 further comprising placing a rotor in the stator, the rotor including a lobe configured to rotate in the stator.

16. The method of claim 10, wherein the first material is selected from a group consisting of: a ceramic material, a composite material; a carbon fiber material; a metal alloy; and a combination of a metal and a non-metallic material.

17. The method of claim 16 further comprising coupling a drill bit to the rotor.

18. A method of using a drilling motor for drilling a wellbore, the method comprising:
attaching a drilling motor to a drilling assembly, the drilling motor including a stator that has a housing with an inner contour, and a liner lining the inner contour of the stator housing, wherein thickness of the liner is non-equidistant around the inner contour of the housing;
coupling a drill bit to the drilling assembly;
deploying the drilling assembly in a wellbore with a tubular; and
drilling the wellbore by rotating the drill bit with the drilling motor.

19. The method of claim 18, wherein the liner in the housing includes a lobe having a lobe top and a lobe bottom and wherein the liner includes a leading side and a trailing side and wherein thickness of the liner across one of the leading edge and the trailing edge is greater than thickness of the liner between the lobe top and the lobe bottom.
